(19) United States
(12) Patent Application Publication
(10) Pub. No.: US 2024/0027884 A1
(43) Pub. Date: Jan. 25, 2024

(54) ILLUMINATION SYSTEM AND PROJECTION APPARATUS

(71) Applicant: Coretronic Corporation, Hsin-Chu (TW)

(72) Inventors: Jui Chang, Hsin-Chu (TW); Kuan-Ta Huang, Hsin-Chu (TW); Jo-Han Hsu, Hsin-Chu (TW)

(73) Assignee: Coretronic Corporation, Hsin-Chu (TW)

(21) Appl. No.: 18/354,671

(22) Filed: Jul. 19, 2023

(30) Foreign Application Priority Data
Jul. 20, 2022 (CN) 202210863194.2

(51) Int. Cl. G03B 21/20

(52) U.S. Cl. CPC G03B 21/2013; G03B 21/2066

(57) ABSTRACT

An illumination system includes first to third reflection components, a first light splitting and combining element, and a lens. The first and second reflection components reflect a first color beam and another first color beam, respectively. The third reflection element reflects a second color beam and another second color beam. The first light splitting and combining element passes the second color beams and reflects the first color beams. The first color beams and the second color beams leaving the first light splitting and combining element respectively form first and second irradiation areas not overlapped with each other and third and fourth irradiation areas not overlapped with each other on the lens, and each of the first and second irradiation areas are overlapped with at least a portion of the third and fourth irradiation areas.

### CROSS-REFERENCE TO RELATED APPLICATION

This application claims the priority benefit of China application serial no. 202210863194.2 filed on Jul. 20, 2022. The entirety of the above-mentioned patent application is hereby incorporated by reference herein and made a part of this specification.

### BACKGROUND

### Technical Field

The technical field relates to a projection technique, and in particular, to an illumination system and a projection apparatus.

### Description of Related Art

In recent years, the appearance of portable projection apparatuses has improved in terms of convenience of use, and may also meet the needs of use in different situations. In order to reduce the manufacturing cost of the projection apparatus and reduce the volume of the projection apparatus, a plurality of light sources used to generate light of different colors are manufactured on the same plate in a modularized manner. However, the arrangement of the light sources on the plate is not symmetrical, thus readily affecting the brightness uniformity of the beam on the projection surface.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides an illumination system with better uniformity of light output.

The disclosure provides a projection apparatus with better brightness uniformity of a projection image, and the opto-mechanical design flexibility of the projection apparatus is also greater.

Other objects and advantages of the disclosure may be further understood from the technical features disclosed in the disclosure.

In order to achieve one or part or all of the above objects or other objects, an embodiment of the invention provides an illumination system. The illumination system includes a first light source module, a second light source module, a first reflection component, a second reflection component, a third reflection element, a first light splitting and combining element, and a lens. The first light source module is used to generate a first color beam and a second color beam. The second light source module is used to generate another first color beam and another second color beam. The first reflection component is disposed on a transmission path of the first color beam and used to reflect the first color beam. The second reflection component is disposed on a transmission path of the other first color beam and used to reflect the other first color beam. The third reflection element is disposed on a transmission path of the second color beam and the other second color beam and used to reflect the second color beam and the other second color beam. The first light splitting and combining element is disposed on a transmission path of the first color beam from the first reflection component, a transmission path of the other first color beam from the second reflection component, and a transmission path of the second color beam and the other second color beam from the third reflection element. The first light splitting and combining element is configured to allow the second color beam and the other second color beam to pass through and reflect the first color beam and the other first color beam. The lens is disposed on a transmission path of the first color beam, the other first color beam, the second color beam, and the other second color beam from the first light splitting and combining element. The first color beam and the other first color beam respectively form a first irradiation area and a second irradiation area not overlapped with each other on the lens. The second color beam and the other second color beam respectively form a third irradiation area and a fourth irradiation area not overlapped with each other on the lens, and each of the first irradiation area and the second irradiation area are overlapped with at least a portion of the third irradiation area and at least a portion of the fourth irradiation area.

In order to achieve one or a portion of or all of the above objects or other objects, an embodiment of the invention provides a projection apparatus. The projection apparatus includes an illumination system, a light valve, and a projection lens. The illumination system includes a first light source module, a second light source module, a first reflection component, a second reflection component, a third reflection element, a first light splitting and combining element, and a lens. The first light source module is used to generate a first color beam and a second color beam. The second light source module is used to generate another first color beam and another second color beam. The first reflection component is disposed on a transmission path of the first color beam and used to reflect the first color beam. The second reflection component is disposed on a transmission path of the other first color beam and used to reflect the other first color beam. The third reflection element is disposed on a transmission path of the second color beam and the other second color beam and used to reflect the second color beam and the other second color beam. The first light splitting and combining element is disposed on a transmission path of the first color beam from the first reflection component, a transmission path of the other first color beam from the second reflection component, and a transmission path of the second color beam and the other second color beam from the third reflection element. The first light splitting and combining element is used to allow the second color beam and the other second color beam to pass through and reflect the first color beam and the other first color beam. The lens is disposed on a transmission path of the first color beam, the other first color beam, the second color beam, and the other second color beam from the first light splitting and combining element. The first color beam and the other first color beam respectively form a first irradiation area and a second irradiation area not overlapped with each other on the lens. The second color beam and the other second color beam respectively form a third irradiation area and a fourth irradiation area not overlapped with each other on the lens, and each of the first irradiation area and the second irradiation area are overlapped with at least a portion of the third irradiation area and at least a portion of the fourth irradiation area. The first color beam, the other first color beam, the second color beam, and the other second color beam form an illumination beam after leaving the lens. The light valve is disposed on a transmission path of the illumination beam and used to convert the illumination beam into an image beam. The projection lens is disposed on a transmission path of the image beam and used to project the image beam out of the projection apparatus.

Based on the above, in the illumination system and the projection apparatus of an embodiment of the invention, the first color beam from the first light source module forms the first irradiation area on the lens after being reflected by the first reflection component and the first light splitting and combining element. The other first color beam from the second light source module forms the second irradiation area on the lens after being reflected by the second reflection component and the first light splitting and combining element. The second color beam from the first light source module passes through the first light splitting and combining element after being reflected by the third reflection element, and forms the third irradiation area on the lens. The other second color beam from the second light source module passes through the first light splitting and combining element after being reflected by the third reflection element, and forms the fourth irradiation area on the lens. The first irradiation area and the second irradiation area not overlapped with each other are respectively overlapped with at least a portion of the third irradiation area and at least a portion of the fourth irradiation area to effectively improve the light output uniformity of the illumination system and significantly reduce the difficulty of opto-mechanical design of the projection apparatus.

Other objectives, features and advantages of the disclosure will be further understood from the further technological features disclosed by the embodiments of the disclosure wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a projection apparatus according to an embodiment of the invention.

FIG. 2 is an enlarged schematic view of the illumination system of FIG. 1.

FIG. 3 and FIG. 4 are schematic views of the illumination system of FIG. 1 from different viewing angles, respectively.

FIG. 5 is a top schematic view of the illumination system of FIG. 1.

FIG. 6 is a partial enlarged schematic view of the illumination system of FIG. 2.

FIG. 7A to FIG. 7C are schematic views of irradiation areas of beams of different colors of the two light source modules of FIG. 2 on a lens.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

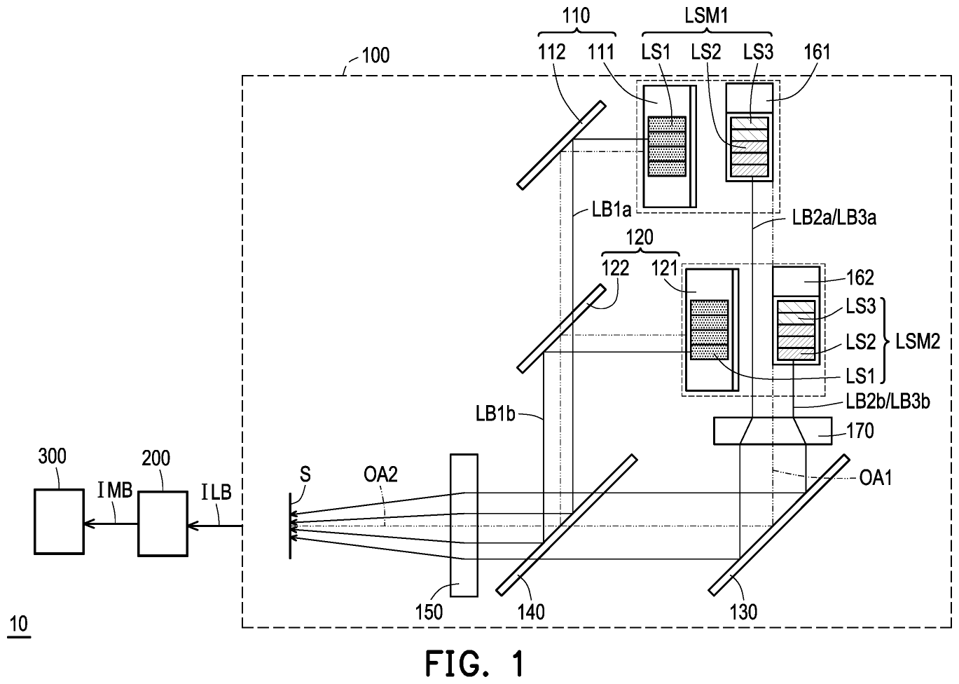

FIG. 1 is a schematic view of a projection apparatus according to an embodiment of the invention. A projection apparatus 10 includes an illumination system 100, a light valve 200, and a projection lens 300. The illumination system 100 is configured to provide an illumination beam ILB The light valve 200 is disposed on the transmission path of the illumination beam ILB and configured to convert the illumination beam ILB into an image beam IMB. The projection lens 300 is disposed on the transmission path of the image beam IMB and configured to project the image beam IMB onto a screen, a wall, or other objects that may be used for imaging. For example, the light valve 200 may be a digital micro-mirror device (DMD), a liquid-crystal-on-silicon (LCOS) panel, or a transmissive liquid-crystal panel, but the invention is not limited thereto. The projection lens 300 includes, for example, a combination of one or a plurality of optical lenses having a refractive power, including, for example, various combinations of a non-planar lens such as a biconcave lens, a lenticular lens, a convex-concave lens, a concave-convex lens, a plano-convex lens, a plano-concave lens, and the like. In an embodiment, the projection lens 300 may also include a flat optical lens. Here, the present embodiment does not limit the configuration and type of the projection lens 300.

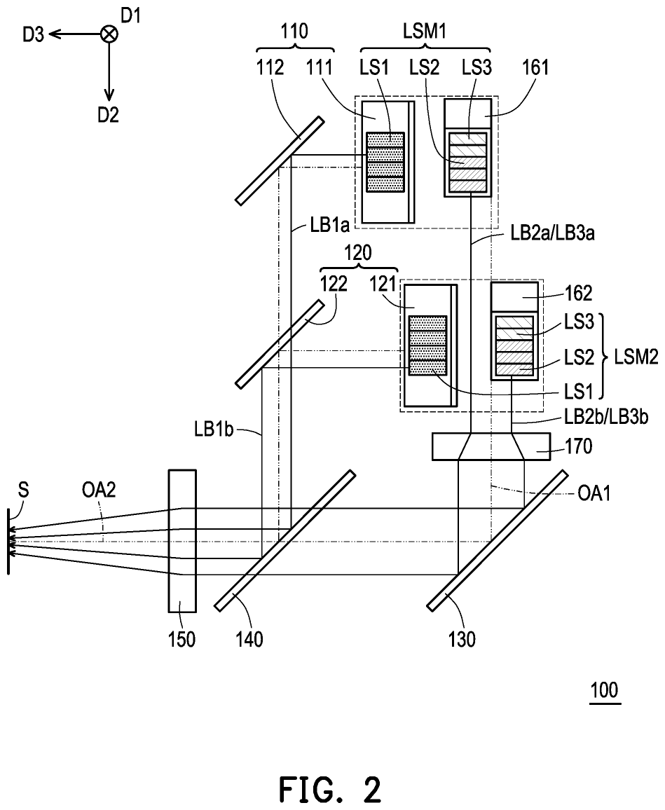

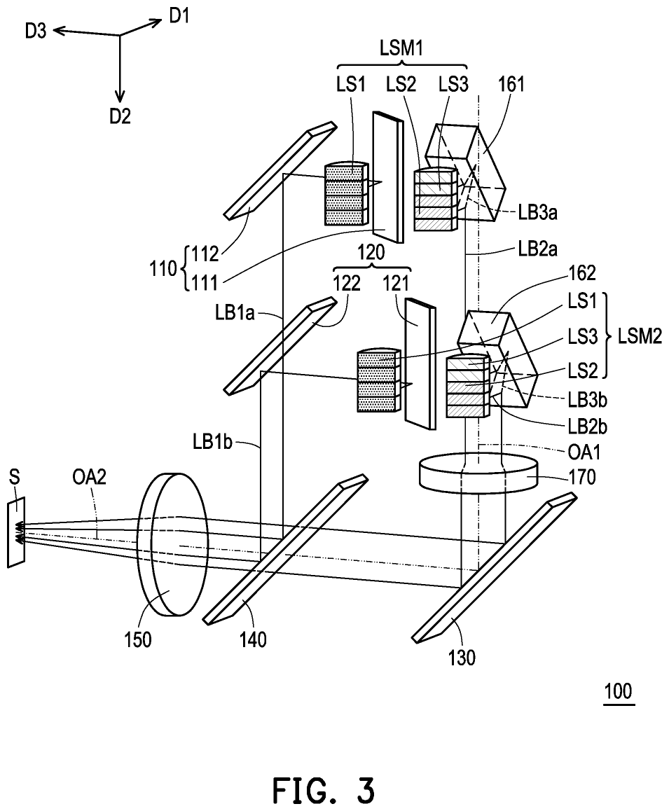

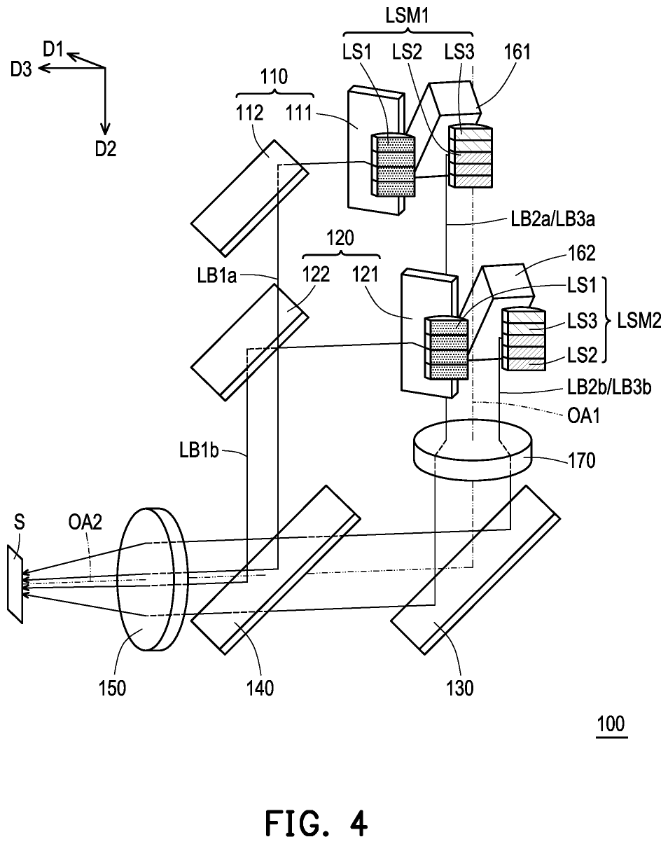

Please refer to FIG. 2 to FIG. 4 at the same time. FIG. 2 is an enlarged schematic view of the illumination system of FIG. 1. FIG. 3 and FIG. 4 are schematic views of the illumination system of FIG. 1 from different viewing angles, respectively. The illumination system 100 includes a first light source module LSM1, a second light source module LSM2, a first reflection component 110, a second reflection component 120, a reflection element 130 (i.e., a third reflection element), and a first light splitting and combining element 140. For example, in the present embodiment, each of the first light source module LSM1 and the second light source module LSM2 may include, a first light source LS1, a second light source LS2, and a third light source LS3 configured to respectively generate a first color beam (a first color beam LB1a and another first color beam LB1b), a second color beam (a second color beam LB2a and another second color beam LB2b), and a third color beam (a third color beam LB3a and another third color beam LB3b). In the present embodiment, the first light source LS1, the second light source LS2, and the third light source LS3 are, for example, one or more light-emitting diodes (LEDs) or laser diodes (LDs) used to generate red light, green light, and blue light, respectively, or a combination thereof, or other suitable light sources, but not limited thereto.

In the present embodiment, four first light sources LS1, three second light sources LS2, and two third light sources LS3 may be integrated on the same plate (not numbered), and packaged into the light source module of the present embodiment, such as the first light source module LSM1 or the second light source module LSM2. As shown in FIG. 1 to FIG. 2, along a direction D1, the first light sources LS1, the second light sources LS2 and the third light sources LS3 of each light source module LSM1 and LSM2 are disposed between the reflection elements 111 and 161 and the plate which the first light sources LS1, the second light sources LS2, and the third light sources LS3 are integrated on. The plate shown in FIG. 1 and FIG. 2 is illustrated by a dashed frame enclosing the first light sources LS1, the second light sources LS2, and the third light sources LS3. In other embodiments, the types of light sources (such as wavelengths of light sources) included in the light source module and the corresponding quantity of light sources may be adjusted according to actual product applications. For the convenience of explanation, the plate which four first light sources LS1, three second light sources LS2, and two third light sources LS3 are integrated on is not shown in FIG. 3 to FIG. 4.

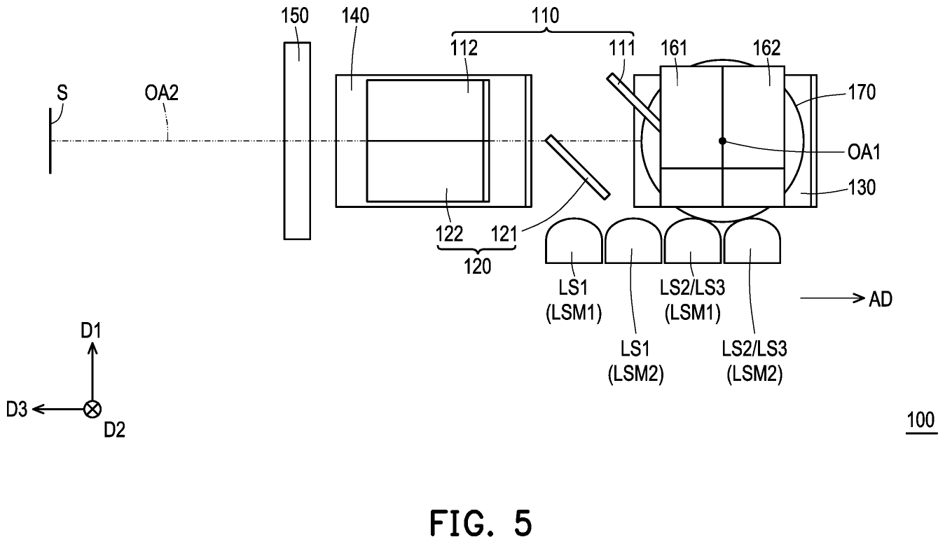

Please refer to FIG. 5 at the same time. FIG. 5 is a top schematic view of the illumination system of FIG. 1. For example, the long axes of the first light source module LSM1 and the second light source module LSM2 of the present embodiment may be arranged along a direction D2 in FIG. 2. On the reference plane perpendicular to the direction D2, the first light source LS1 and second light source LS2 (or the third light source LS3) of each of the first light source module LSM1 and the second light source module LSM2 are arranged along an arrangement direction AD, and an arrangement direction (e.g., the direction D2) of the three second light sources LS2 and the two third light sources LS3 of each light source module is parallel to an arrangement direction of the four first light sources LS1 of the corresponding light source module. In an embodiment, the arrangement direction AD and the direction D2 may be perpendicular to each other. It should be noted that, the first light source LS1 and the second light source LS2 (or the third light source LS3) of the first light source module LSM1 are staggered along the arrangement direction AD from the first light source LS1 and the second light source LS2 (or the third light source LS3) of the second light source module LSM2. That is, on the reference plane perpendicular to the direction D2, the first light source LS1 of the first light source module LSM1, the first light source LS1 of the second light source module LSM2, the second light source LS2 (or the third light source LS3) of the first light source module LSM1, and the second light source LS2 (or the third light source LS3) of the second light source module LSM2 are sequentially arranged along the arrangement direction AD.

Further, the first reflection component 110 is disposed on the transmission path of the first color beam LB1a from the first light source module LSM1 and used to reflect the first color beam LB1a. The second reflection component 120 is disposed on the transmission path of another first color beam LB1b from the second light source module LSM2 and used to reflect the other first color beam LB1b. The reflection element 130 is disposed on the transmission path of the second color beam LB2a from the first light source module LSM1 and the other second color beam LB2b from the second light source module LSM2 and used to reflect the second color beam LB2a and the other second color beam LB2b.

The first light splitting and combining element 140 is disposed on the transmission path of the first color beam LB1a from the first reflection component 110, the transmission path of the other first color beam LB1b from the second reflection component 120, and the transmission path of the second color beam LB2a and the other second color beam LB2b from the reflection element 130. The first light splitting and combining element 140 is used to allow the second color beam LB2a and the other second color beam LB2b to pass through and reflect the first color beam LB1a and the other first color beam LB1b.

In detail, in the present embodiment, the first reflection component 110 may include a reflection element 111 (i.e., a first reflection element) and a reflection element 112 (i.e., a fourth reflection element). The reflection element 111 is disposed on the transmission path of the first color beam LB1a from the first light source module LSM1. The reflection element 112 is disposed on the transmission path of the first color beam LB1a from the reflection element 111. For example, the first color beam LB1a generated by the first light source LS1 of the first light source module LSM1 is transmitted along the direction D1 (as shown in FIG. 3 and FIG. 4) to the reflection element 111. After being reflected by the reflection element 111, the first color beam LB1a is instead transmitted along a direction D3 and incident on the reflection element 112. The first color beam LB1a reflected by the reflection element 112 is transmitted along the direction D2 and incident on the first light splitting and combining element 140. In an embodiment, the direction D1, the direction D2, and the direction D3 may be perpendicular to each other.

Similarly, the second reflection component 120 may include a reflection element 121 (i.e., a second reflection element) and a reflection element 122 (i.e., a fifth reflection element). The reflection element 121 is disposed on the transmission path of the other first color beam LB1b from the second light source module LSM2, and the reflection element 122 is disposed on the transmission path of the other first color beam LB1b from the reflection element 121. For example, the other first color beam LB1b generated by the first light source LS1 of the second light source module LSM2 is transmitted along the direction D1 to the reflection element 121. After being reflected by the reflection element 121, the other first color beam LB1b is instead transmitted along the direction D3 and incident on the reflection element 122. The other first color beam LB1b reflected by the reflection element 122 is transmitted along the direction D2 and incident on the first light splitting and combining element 140.

More specifically, the main optical axis of the first color beam LB1a from the first light source LS1 of the first light source module LSM1 is parallel to and not overlapped with the main optical axis of the other first color beam LB1b of the other first light source LS1 from the second light source module LSM2.

Moreover, in the present embodiment, the illumination system 100 may further include a second light splitting and combining element 161 and a third light splitting and combining element 162. The second light splitting and combining element 161 is disposed between the transmission path of the second color beam LB2a from the second light source LS2 of the first light source module LSM1 and the transmission path of the third color beam LB3a from the third light source LS3 of the first light source module LSM1. The third light splitting and combining element 162 is disposed between the transmission path of the other second color beam LB2b from the second light source LS2 of the second light source module LSM2 and the transmission path of the other third color beam LB3b from the third light source LS3 of the second light source module LSM2.

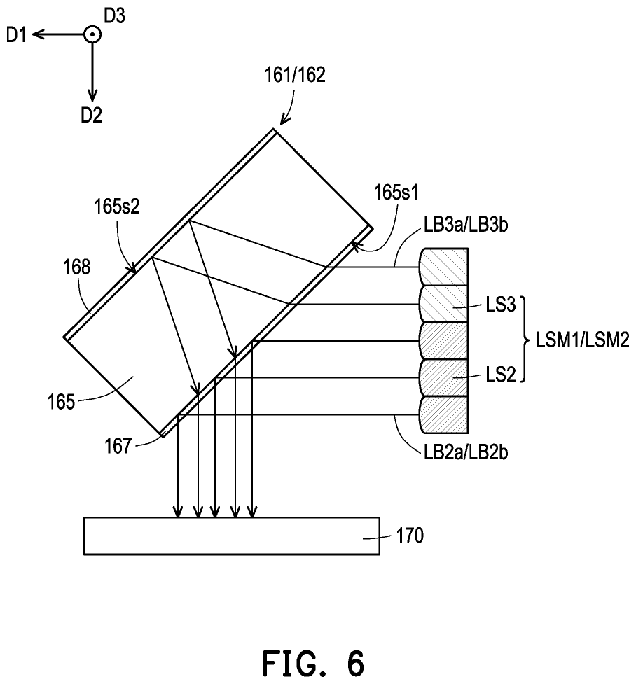

Please refer to FIG. 6 at the same time. FIG. 6 is a partial enlarged schematic view of the illumination system of FIG. 2. In detail, each of the second light splitting and combining element 161 and the third light splitting and combining element 162 includes a light-transmitting substrate 165, a first light transmission element 167, and a second light transmission element 168. The light-transmitting substrate 165 has a surface 165s1 facing the second color beam (the second color beam LB2a or the other second color beam LB2b) or the third color beam (the third color beam LB3a or the other third color beam LB3b) from the light source module (the first light source module LSM1 or the second light source module LSM2) and another surface 165s2 away from the light source module. The first light transmission element 167 and the second light transmission element 168 are respectively disposed at two opposite sides (the surface 165s1 and the surface 165s2) of the light-transmitting substrate 165.

The material of the light-transmitting substrate 165 is, for example, glass or other light-transmitting materials. The material of the first light transmission element 167 and the second light transmission element 168 may be selected from titanium dioxide (TiO₂), silicon dioxide (SiO₂), or other suitable materials, but is not limited thereto. In some embodiments, the material of the first light transmission element 167 and the second light transmission element 168 is different. In other embodiments, the material of the first light transmission element 167 and the second light transmission element 168 may be the same, but the thickness of the material of the first light transmission element 167 and the second light transmission element 168 may be different. In particular, the “light transmission element” herein is defined as an element that may provide a light transmission effect of reflecting a beam of a specific wavelength or passing a beam of a specific wavelength.

In the present embodiment, the first light transmission element 167 is, for example, a dielectric layer coating attached to the light-transmitting substrate 165 and having a light-splitting function, and is selective for beams of different wavelengths. Therefore, different light transmission effects (such as reflection or passing) may be respectively provided for incident beams of different wavelengths to obtain light splitting effect.

For example, the first light transmission element 167 is designed to reflect the second color beams (LB2a and LB2b) (such as green laser) and allow the third color beams (LB3a and LB3b) (such as blue laser) to pass through, and the second light transmission element 168 is designed to reflect the third color beams (LB3a and LB3b). In other embodiments, the respective reflected light wavelengths or transmitted light wavelengths of the first light transmission element 167 and the second light transmission element 168 may be adjusted according to actual product applications.

More specifically, in the present embodiment, the second color beam LB2a incident on the second light splitting and combining element 161 may be reflected by the first light transmission element 167 of the second light splitting and combining element 161 to leave the second light splitting and combining element 161, and the other second color beam LB2b incident on the third light splitting and combining element 162 may be reflected by the first light transmission element 167 of the third light splitting and combining element 162 to leave the third light splitting and combining element 162. After the third color beam LB3a incident on the second light splitting and combining element 161 passes through the first light transmission element 167 of the second light splitting and combining element 161 and the light-transmitting substrate 165 and is reflected by the second light transmission element 168, the third color beam LB3a passes through the light-transmitting substrate 165 and the first light transmission element 167 and leaves the second light splitting and combining element 161. After the other third color beam LB3b incident on the third light splitting and combining element 162 passes through the first light transmission element 167 and the light-transmitting substrate 165 of the third light splitting and combining element 162 and is reflected by the second light transmission element 168 of the third light splitting and combining element 162, the other third color beam LB3b passes through the light-transmitting substrate 165 and the first light transmission element 167 of the third light splitting and combining element 162 again and leaves the third light splitting and combining element 162.

It should be noted that, the second color beam LB2a and the third color beam LB3a emitted from the first light source module LSM1 are parallel to each other, and the transmission paths of the main optical axes (i.e., LB2a and LB3a as shown in FIG. 6) of the second color beam LB2a and the third color beam LB3a leaving the second light splitting and combining element 161 are parallel to each other but not coincident. The other second color beam LB2b and the other third color beam LB3b emitted from the second light source module LSM2 are parallel to each other, and the transmission paths of the main optical axes of the other second color beam LB2b and the other third color beam LB3b leaving the third light splitting and combining element 162 are parallel to each other but not coincident. In another embodiment, according to the needs of use, the transmission paths of the main optical axes of the second color beam LB2a and the third color beam LB3a (the other second color beam LB2b and the other third color beam LB3b) leaving the second light splitting and combining element 161 (the third light splitting and combining element 162) are designed to be parallel with each other and coincident, in order to achieve the light combining effect of the beam centers.

Please continue to refer to FIG. 2 to FIG. 5, in the present embodiment, the illumination system 100 may also optionally include a lens group 170 disposed on the transmission path of the second color beam LB2a and the third color beam LB3a from the second light splitting and combining element 161 and on the transmission path of the other second color beam LB2b and the other third color beam LB3b from the third light splitting and combining element 162. The lens group 170 has an optical axis OA1. It is noted that the second light splitting and combining element 161 and the third light splitting and combining element 162 are respectively disposed at two opposite sides of the optical axis OA1 of the lens group 170. More specifically, the second light splitting and combining element 161 and the third light splitting and combining element 162 are respectively disposed at two opposite sides of the reference plane passing through the optical axis OA1 and perpendicular to the direction D3. In addition, the second light splitting and combining element 161 and the third light splitting and combining element 162 are respectively overlapped with two different areas of the lens group 170 along the axial direction of the optical axis OA1. That is, the orthographic projection of the second light splitting and combining element 161 and the third light splitting and combining element 162 on the lens group 170 is overlapped with the lens group 170.

In the present embodiment, the lens group 170 is formed by, for example, at least two lenses, and is used to expand the second color beam LB2a and the third color beam LB3a from the second light splitting and combining element 161 and the other second color beam LB2b and the other third color beam LB3b from the third light splitting and combining element 162. The second color beam LB2a, the third color beam LB3a, the other second color beam LB2b, and the other third color beam LB3b passing through the lens group 170 are transmitted along the direction D2 and incident on the reflection element 130.

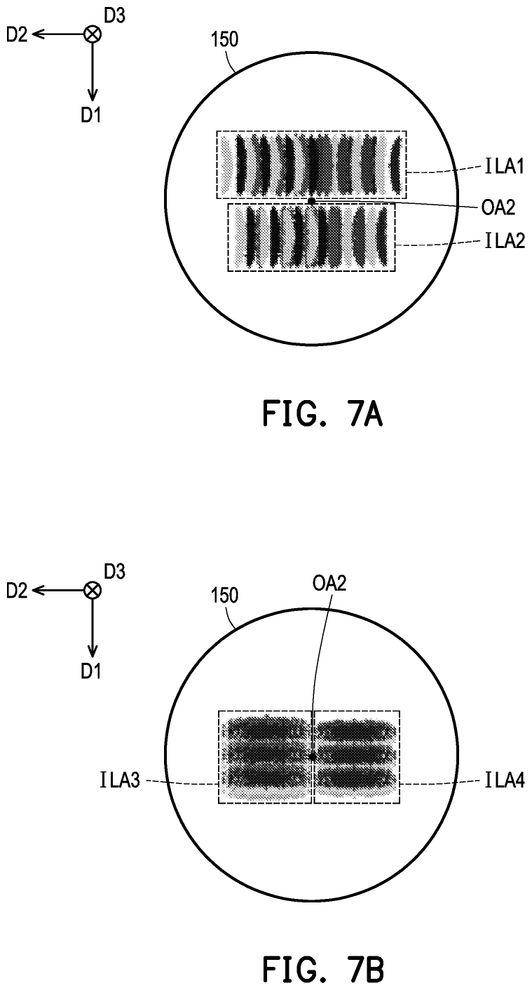

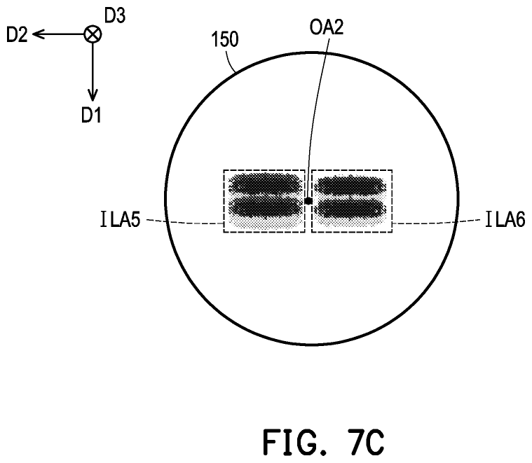

Please refer to FIG. 2 and FIG. 7A to FIG. 7C at the same time. FIG. 7A to FIG. 7C are schematic views of irradiation areas of beams of different colors of the two light source modules of FIG. 2 on a lens. The illumination system 100 further includes a lens 150 disposed on the transmission path of the first color beam LB1a, the other first color beam LB1b, the second color beam LB2a, and the other second color beam LB2b from the first light splitting and combining element 140. The first color beam LB1a and the other first color beam LB1b from the first light splitting and combining element 140 respectively form a first irradiation area ILA1 and a second irradiation area ILA2 not overlapped with each other on the lens 150 (as shown in FIG. 7A). The second color beam LB2a and the other second color beam LB2b from the reflection element 130 and passing through the first light splitting and combining element 140 respectively form a third irradiation area ILA3 and a fourth irradiation area ILA4 not overlapped with each other on the lens 150 (as shown in FIG. 7B). The third color beam LB3a and the other third color beam LB3b from the reflection element 130 and passing through the first light splitting and combining element 140 respectively form a fifth irradiation area ILA5 and a sixth irradiation area ILA6 not overlapped with each other on the lens 150 (as shown in FIG. 7C). The first irradiation area ILA1, the second irradiation area ILA2, the third irradiation area ILA3, the fourth irradiation area ILA4, the fifth irradiation area ILA5, and the sixth irradiation area ILA6 are the areas of a plurality of light spots formed on the lens 150 by the first color beam LB1a, the other first color beam LB1b, second color beam LB2a, the other second color beam LB2b, third color beam LB3a, and the other third color beam LB3b, respectively.

It should be mentioned that, with the arrangement of the first reflection component 110 and the second reflection component 120, the first color beam LB1a generated by the first light source LS1 of the first light source module LSM1 has one more optical path reflection than the second color beam LB2a generated by the second light source LS2 (or the third color beam LB3a generated by the third light source LS3) of the same first light source module LSM1. In detail, after the second color beam LB2a from the first light source module LSM1 is reflected by the second light splitting and combining element 161, the transmission direction thereof may be changed from the direction D1 to the direction D2. During the two reflection processes of the first color beam LB1a from the same first light source module LSM1 via the reflection element 111 and the reflection element 112 of the first reflection component 110, the transmission direction thereof is first changed from the direction D1 to the direction D3, and then changed from the direction D3 to the direction D2. The effect of the second reflection component 120 and the third light splitting and combining element 162 on the color beam from the second light source module LSM2 is similar to the effect of the first reflection component 110 and the second light splitting and combining element 161 on the color beam from the first light source module LSM1, and is therefore not repeated herein.

Therefore, the arrangement direction of the first irradiation area ILA1 and the second irradiation area ILA2 formed on the lens 150 by the first color beam LB1a from the first light source module LSM1 and the other first color beam LB1b from the second light source module LSM2 respectively is different from the arrangement direction of the third irradiation area ILA3 and the fourth irradiation area ILA4 formed on the lens 150 by the second color beam LB2a from the first light source module LSM1 and the other second color beam LB2b from the second light source module LSM2 respectively.

For example, in the present embodiment, the first irradiation area ILA1 of the first color beam LB1a on the lens 150 and the second irradiation area ILA2 of the other first color beam LB1b on the lens 150 are arranged along the direction D1, and are respectively located at two opposite sides of an optical axis OA2 of the lens 150. More specifically, the plurality of light spots of the first color beam LB1a1 and the other first color beam LB1b on the lens 150 are arranged along the direction D2 to form the first irradiation area ILA1 and the second irradiation area ILA2, respectively, and the rectangular outlines of the first irradiation area ILA1 and the second irradiation area ILA2 are embodied as rectangles, and the long sides parallel to the direction D2 in the rectangular outlines of the first irradiation area ILA1 and the second irradiation area ILA2 are adjacent on the lens 150, so that a plurality of light spots may be distributed on the lens 150. The third irradiation area ILA3 of the second color beam LB2a on the lens 150 and the fourth irradiation area ILA4 of the other second color beam LB2b on the lens 150 are arranged along the direction D2 and respectively located at two opposite sides of the optical axis OA2 of the lens 150. More specifically, the plurality of light spots of the second color beam LB2a and the other second color beam LB2b on the lens 150 are arranged along the direction D1 to form the third irradiation area ILA3 and the fourth irradiation area ILA4, respectively, and the sides parallel to the direction D1 in the rectangular outlines of the third irradiation area ILA3 and the fourth irradiation area ILA4 are adjacent on the lens 150.

The present embodiment utilizes the second light splitting and combining element 161 to reflect the second color beam LB2a and the third color beam LB3a generated by the first light source module LSM1, and allows the main optical axes of the second color beam LB2a and the third color beam LB3a be parallel to each other but not coincident with each other on the transmission path after leaving the second light splitting and combining element 161. Therefore, the fifth irradiation area ILA5 of the third color beam LB3a on the lens 150 and the third irradiation area ILA3 of the second color beam LB2a on the lens 150 are at least partially not overlapped along the direction D3. More specifically, a portion of the third irradiation area ILA3 and the fifth irradiation area ILA5 is overlapped and another portion thereof is not overlapped. The geometric centers of the plurality of light spots of the third irradiation area ILA3 and the fifth irradiation area ILA5 are not overlapped with each other. Similarly, the present embodiment further utilizes the third light splitting and combining element 162 to reflect the other second color beam LB2b and the other third color beam LB3b generated by the second light source module LSM2, and allows the main optical axes of the other second color beam LB2b and the other third color beam LB3b be parallel to each other but not coincident with each other on the transmission path after leaving the third light splitting and combining element 162. Therefore, the sixth irradiation area ILA6 of the other third color beam LB3b on the lens 150 and the fourth irradiation area ILA4 of the other second color beam LB2b on the lens 150 are at least partially not overlapped along the direction D3. Since the positional relationship between the other second color beam LB2b and the other third color beam LB3b on the lens 150 is similar to the positional relationship between the second color beam LB2a and the third color beam LB3a on the lens 150, the details are not repeated herein. Moreover, in the present embodiment, the fifth irradiation area ILA5 of the third color beam LB3a on the lens 150 and the sixth irradiation area ILA6 of the other third color beam LB3b on the lens 150 are also arranged along the direction D2 and respectively located at two opposite sides of the optical axis OA2 of the lens 150. Since the arrangement of the third color beam LB3a and the other third color beam LB3b on the lens 150 is similar to the arrangement of the second color beam LB2a and the other second color beam LB2b on the lens 150, the details are not repeated herein.

More specifically, the first irradiation area ILA1 and the second irradiation area ILA2 are each overlapped with a portion of the third irradiation area ILA3, a portion of the fourth irradiation area ILA4, a portion of the fifth irradiation area ILA5, and a portion of the sixth irradiation area ILA6 along the direction D3. From another perspective, the third irradiation area ILA3 is overlapped with a portion of the first irradiation area ILA1, a portion of the second irradiation area ILA2, and a portion of the fifth irradiation area ILA5 along the direction D3, and the fourth irradiation area ILA4 is overlapped with a portion of the first irradiation area ILA1, a portion of the second irradiation area ILA2, and a portion of the sixth irradiation area ILA6 along the direction D3.

In other words, at least a portion of the irradiation areas formed on the lens 150 by beams of different colors (for example, the first color beams (LB1a and LB1b) and the second color beams (LB2a and LB2b), or the first color beams (LB1a and LB1b) and the third color beams (LB3a and LB3b)) from the first light source module LSM1 and the second light source module LSM2 respectively are overlapped with each other. Therefore, beams of different colors from different light source modules may be uniformly mixed, and the uniformity of light output of the illumination system 100 is effectively improved, and the difficulty of opto-mechanical design of the projection apparatus 10 is significantly reduced.

Further, in the present embodiment, the illumination system 100 may include a light-homogenizing element (not shown in the figure). The lens 150 may be configured to converge the first color beam LB1a, the other first color beam LB1b, the second color beam LB2a, the other second color beam LB2b, the third color beam LB3a, and the other third color beam LB3b from the first light splitting and combining element 140 on a light incident surface S of the light-homogenizing element, and the light-homogenizing element is, for example, an optical integrator rod, but not limited thereto.

Based on the above, in the illumination system and the projection apparatus of an embodiment of the invention, the first color beam from the first light source module forms the first irradiation area on the lens after being reflected by the first reflection component and the first light splitting and combining element. The other first color beam from the second light source module forms the second irradiation area on the lens after being reflected by the second reflection component and the first light splitting and combining element. The second color beam from the first light source module passes through the first light splitting and combining element after being reflected by the third reflection element, and forms the third irradiation area on the lens. The other second color beam from the second light source module passes through the first light splitting and combining element after being reflected by the third reflection element, and forms the fourth irradiation area on the lens. The first irradiation area and the second irradiation area not overlapped with each other are respectively overlapped with at least a portion of the third irradiation area and at least a portion of the fourth irradiation area to effectively improve the light output uniformity of the illumination system and significantly reduce the difficulty of opto-mechanical design of the projection apparatus.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising:
a first light source module configured to generate a first color beam and a second color beam;
a second light source module configured to generate another first color beam and another second color beam;
a first reflection component disposed on a transmission path of the first color beam and used to reflect the first color beam;
a second reflection component disposed on a transmission path of the other first color beam and used to reflect the other first color beam;
a third reflection element disposed on a transmission path of the second color beam and the other second color beam and used to reflect the second color beam and the other second color beam;
a first light splitting and combining element disposed on a transmission path of the first color beam from the first reflection component, a transmission path of the other first color beam from the second reflection component, and a transmission path of the second color beam and the other second color beam from the third reflection element, wherein the first light splitting and combining element is configured to allow the second color beam and the other second color beam to pass through and reflect the first color beam and the other first color beam; and
a lens disposed on a transmission path of the first color beam, the other first color beam, the second color beam, and the other second color beam from the first light splitting and combining element, wherein the first color beam and the other first color beam respectively form a first irradiation area and a second irradiation area not overlapped with each other on the lens, the second color beam and the other second color beam respectively form a third irradiation area and a fourth irradiation area not overlapped with each other on the lens, and the first irradiation area and the second irradiation area respectively are overlapped with at least a portion of the third irradiation area and at least a portion of the fourth irradiation area.

2. The illumination system of claim 1, wherein the first irradiation area and the second irradiation area are arranged along a first direction, the third irradiation area and the fourth irradiation area are arranged along a second direction, and the first direction is perpendicular to the second direction.

3. The illumination system of claim 1, further comprising:
a second light splitting and combining element disposed on a transmission path of the second color beam, wherein the second color beam from the first light source module is transmitted along a first direction, the second color beam from the second light splitting and combining element is transmitted along a second direction, and the first direction and the second direction are perpendicular to each other; and
a third light splitting and combining element disposed on a transmission path of the other second color beam, wherein the other second color beam from the second light source module is transmitted along the first direction, the other second color beam from the third light splitting and combining element is transmitted along the second direction, and the third reflection element is disposed on a transmission path of the second color beam from the second light splitting and combining element and a transmission path of the other second color beam from the third light splitting and combining element.

4. The illumination system of claim 3, further comprising:
a lens group disposed on a transmission path of the second color beam from the second light splitting and combining element and a transmission path of the other second color beam from the third light splitting and combining element, wherein the lens group has an optical axis, the second light splitting and combining element and the third light splitting and combining element are respectively disposed at two opposite sides of the optical axis of the lens group, and an orthographic projection of the second light splitting and combining element and the third light splitting and combining element on the lens group is overlapped with the lens group.

5. The illumination system of claim 3, wherein the second light splitting and combining element and the third light splitting and combining element respectively comprise a light-transmitting substrate and a first light transmission element, the first light transmission element is provided at a side surface of the light-transmitting substrate facing the second color beam, the second color beam incident on the second light splitting and combining element is reflected by the first light transmission element of the second light splitting and combining element and leaves the second light splitting and combining element, and the other second color beam incident on the third light splitting and combining element is reflected by the first light transmission element of the third light splitting and combining element and leaves the third light splitting and combining element.

6. The illumination system of claim 5, wherein the first light source module is also configured to generate a third color beam, the second light source module is also configured to generate another third color beam, each of the second light splitting and combining element and the third light splitting and combining element further comprise a second light transmission element disposed on another side surface of the light-transmitting substrate away from the first light transmission element, after the third color beam incident on the second light splitting and combining element passes through the first light transmission element and the light-transmitting substrate of the second light splitting and combining element and is reflected by the second light transmission element, the third color beam passes through the light-transmitting substrate and the first light transmission element again and leaves the second light splitting and combining element, and after the other third color beam incident on the third light splitting and combining element passes through the first light transmission element and the light-transmitting substrate of the third light splitting and combining element and is reflected by the second light transmission element, the other third color beam passes through the light-transmitting substrate and the first light transmission element again and leaves the third light splitting and combining element.

7. The illumination system of claim 6, wherein the third color beam and the second color beam from the first light source module are parallel to each other, the other third color beam and the other second color beam from the second light source module are parallel to each other, transmission paths of main optical axes of the second color beam and the third color beam leaving the second light splitting and combining element are parallel to each other but not coincident, and transmission paths of main optical axes of the other second color beam and the other third color beam leaving the third light splitting and combining element are parallel to each other but not coincident.

8. The illumination system of claim 1, wherein the first reflection component comprises a first reflection element and a fourth reflection element, the fourth reflection element is disposed on a transmission path of the first color beam from the first reflection element, the first color beam from the first light source module is transmitted along a first direction, the first color beam from the first reflection element is transmitted along a third direction, the first color beam from the fourth reflection element is transmitted along a second direction, the second reflection component comprises a second reflection element and a fifth reflection element, the fifth reflection element is disposed on a transmission path of the other first color beam from the second reflection element, the other first color beam from the second light source module is transmitted along the first direction, the other first color beam from the second reflection element is transmitted along the third direction, the other first color beam from the fifth reflection element is transmitted along the second direction, and the first direction, the second direction, and the third direction are perpendicular to each other.

9. The illumination system of claim 1, wherein the first light source module comprises a first light source and a second light source arranged along an arrangement direction, the first light source is used to generate the first color beam, the second light source is used to generate the second color beam, the second light source module comprises another first light source and another second light source arranged along the arrangement direction, the other first light source is used to generate the other first color beam, the other second light source is used to generate the other second color beam, and the first light source and the second light source of the first light source module are staggered along the arrangement direction to the other first light source and the other second light source of the second light source module.

10. A projection apparatus, comprising:
an illumination system, comprising:
a first light source module configured to generate a first color beam and a second color beam;
a second light source module configured to generate another first color beam and another second color beam;
a first reflection component disposed on a transmission path of the first color beam and used to reflect the first color beam;
a second reflection component disposed on a transmission path of the other first color beam and used to reflect the other first color beam;
a third reflection element disposed on a transmission path of the second color beam and the other second color beam and used to reflect the second color beam and the other second color beam;
a first light splitting and combining element disposed on a transmission path of the first color beam from the first reflection component, a transmission path of the other first color beam from the second reflection component, and a transmission path of the second color beam and the other second color beam from the third reflection element, wherein the first light splitting and combining element is configured to allow the second color beam and the other second color beam to pass through and reflect the first color beam and the other first color beam; and
a lens disposed on a transmission path of the first color beam, the other first color beam, the second color beam, and the other second color beam from the first light splitting and combining element, wherein the first color beam and the other first color beam respectively form a first irradiation area and a second irradiation area not overlapped with each other on the lens, the second color beam and the other second color beam respectively form a third irradiation area and a fourth irradiation area not overlapped with each other on the lens, and the first irradiation area and the second irradiation area respectively are overlapped with at least a portion of the third irradiation area and at least a portion of the fourth irradiation area, and the first color beam, the other first color beam, the second color beam, and the other second color beam form an illumination beam after leaving the lens;
a light valve disposed on a transmission path of the illumination beam and used to convert the illumination beam into an image beam; and
a projection lens disposed on a transmission path of the image beam and used to project the image beam out of the projection apparatus.

11. The projection apparatus of claim 10, wherein the first irradiation area and the second irradiation area are arranged along a first direction, the third irradiation area and the fourth irradiation area are arranged along a second direction, and the first direction is perpendicular to the second direction.

12. The projection apparatus of claim 10, wherein the illumination system further comprises:
a second light splitting and combining element disposed on a transmission path of the second color beam, wherein the second color beam from the first light source module is transmitted along a first direction, the second color beam from the second light splitting and combining element is transmitted along a second direction, and the first direction and the second direction are perpendicular to each other; and
a third light splitting and combining element disposed on a transmission path of the other second color beam, wherein the other second color beam from the second light source module is transmitted along the first direction, the other second color beam from the third light splitting and combining element is transmitted along the second direction, and the third reflection element is disposed on a transmission path of the second color beam from the second light splitting and combining element and a transmission path of the other second color beam from the third light splitting and combining element.

13. The projection apparatus of claim 12, wherein the illumination system further comprises:
a lens group disposed on a transmission path of the second color beam from the second light splitting and combining element and a transmission path of the other second color beam from the third light splitting and combining element, wherein the lens group has an optical axis,
wherein the second light splitting and combining element and the third light splitting and combining element are respectively disposed at two opposite sides of the optical axis of the lens group, and an orthographic projection of the second light splitting and combining element and the third light splitting and combining element at the lens group is overlapped with the lens group.

14. The projection apparatus of claim 12, wherein the second light splitting and combining element and the third light splitting and combining element respectively comprise a light-transmitting substrate and a first light transmission element, wherein the first light transmission element is provided on a side surface of the light-transmitting substrate facing the second color beam, the second color beam incident on the second light splitting and combining element is reflected by the first light transmission element of the second light splitting and combining element and leaves the second light splitting and combining element, and the other second color beam incident on the third light splitting and combining element is reflected by the first light transmission element of the third light splitting and combining element and leaves the third light splitting and combining element.

15. The projection apparatus of claim 14, wherein the first light source module is also configured to generate a third color beam, the second light source module is also configured to generate another third color beam, each of the second light splitting and combining element and the third light splitting and combining element further comprise a second light transmission element disposed on another side surface of the light-transmitting substrate away from the first light transmission element, after the third color beam incident on the second light splitting and combining element passes through the first light transmission element and the light-transmitting substrate of the second light splitting and combining element and is reflected by the second light transmission element, the third color beam passes through the light-transmitting substrate and the first light transmission element again and leaves the second light splitting and combining element, and after the other third color beam incident on the third light splitting and combining element passes through the first light transmission element and the light-transmitting substrate of the third light splitting and combining element and is reflected by the second light transmission element, the other third color beam passes through the light-transmitting substrate and the first light transmission element again and leaves the third light splitting and combining element.

16. The projection apparatus of claim 15, wherein the third color beam and the second color beam from the first light source module are parallel to each other, the other third color beam and the other second color beam from the second light source module are parallel to each other, transmission paths of main optical axes of the second color beam and the third color beam leaving the second light splitting and combining element are parallel to each other but not coincident, and transmission paths of main optical axes of the other second color beam and the other third color beam leaving the third light splitting and combining element are parallel to each other but not coincident.

17. The projection apparatus of claim 10, wherein the first reflection component comprises a first reflection element and a fourth reflection element, the fourth reflection element is disposed on a transmission path of the first color beam from the first reflection element, the first color beam from the first light source module is transmitted along a first direction, the first color beam from the first reflection element is transmitted along a third direction, and the first color beam from the fourth reflection element is transmitted along a second direction, wherein the second reflection component comprises a second reflection element and a fifth reflection element, the fifth reflection element is disposed on a transmission path of the other first color beam from the second reflection element, the other first color beam from the second light source module is transmitted along the first direction, the other first color beam from the second reflection element is transmitted along the third direction, the other first color beam from the fifth reflection element is transmitted along the second direction, and the first direction, the second direction, and the third direction are perpendicular to each other.

18. The projection apparatus of claim 10, wherein the first light source module comprises a first light source and a second light source arranged along an arrangement direction, the first light source is used to generate the first color beam, the second light source is used to generate the second color beam, the second light source module comprises another first light source and another second light source arranged along the arrangement direction, the other first light source is used to generate the other first color beam, the other second light source is used to generate the other second color beam, and the first light source and the second light source of the first light source module are staggered along the arrangement direction to the other first light source and the other second light source of the second light source module.
